(19) United States
(12) Patent Application Publication
(10) Pub. No.: US 2023/0159774 A1
(43) Pub. Date: May 25, 2023

(54) HIGH ELONGATION LIQUID LAMINATE PRINTED VIA INKJET PRINTING PROCESS

(71) Applicant: Electronics for Imaging, Inc., Fremont, CA (US)

(72) Inventor: Darrel Talley, Kansas City, MO (US)

(21) Appl. No.: 17/535,362

(22) Filed: Nov. 24, 2021

(51) Int. Cl. C09D 11/30; B41M 7/00; B41J 11/00

(52) U.S. Cl. CPC C09D 11/30; B41M 7/0081; B41J 11/00214

(57) ABSTRACT

The radiation curable ink compositions exhibit fasting curing, high flexibility and good adhesion to a broad range of substrates. The ink compositions include a dendritic or hyperbranched polyester acrylate component, which is present in an amount of 10-45% by weight and has a functionality of greater than 5. The compositions further include an oligomer component, a monomer component, a photoinitiator component, a colorant component, and an additive component. The compositions have a viscosity of not greater than 40 cP at 25° C. The radiation curable compositions are suitable for inkjet printing on a variety of substrates.

### TECHNICAL FIELD

The disclosure relates generally to the field of ink compositions. More specifically, the disclosure relates to radiation curable ink compositions that laminate work products.

### BACKGROUND

Currently, lamination is performed via screen printing and/or a laminating machine that uses plastic sheets. Graphics are applied by the screen-printing process on to a high-performance vinyl film and either capped with an expensive over laminate or applying a coating via a roll coating process. Both methods of application are slow inefficient means of processing which take more production time and added expense to process.

The additional cost of applying the laminate or coating offline is between $0.60-1.10 per square foot this would not include the roll coating and laminating equipment which could cost hundreds of thousands of dollars to purchase in order apply the laminate or coating to protect the graphics on a product line.

### BRIEF DESCRIPTION OF THE FIGURES

FIG. 1 is a flowchart illustrating a method of employing clear ink laminate.

FIG. 2 is an illustration of a single-pass inkjet printer. The illustrated printer 200 is for industrial use.

FIG. 3 shows a diagrammatic representation of a machine in the example form of a computer system within which a set of instructions for causing the machine to perform one or more of the methodologies discussed herein may be executed.

### DETAILED DESCRIPTION

The disclosure generally relates to radiation curable ink compositions for ink-jet printing. The ink compositions comprise a clear ink that is a substitute/replacement for laminate layers applied via other known methods (e.g., screen printing or roll coating). The ink compositions are directed to inkjet printing, which includes the delivery of the ink compositions to a substrate and subsequent exposure of the ink compositions to radiation to cure the ink compositions on the substrates.

Currently, the means of applying lamination involves first printing graphics by the screen-printing process. The graphics are printed on to a high-performance vinyl film and either capping them with an expensive over laminate or applying a coating that is applied by the roll coating process. Both methods of application are slow inefficient means of processing which take more production time and added expense to process. Both methods involve the use of an additional machine and require human support to process between machines and additional operation of the machines.

Screen printing requires the generation of multiple screens prior to printing. The process of producing the screens prior to printing is very extensive. Steps of generation include: stretching fabric screens over a screen frame, applying a photo emulsion with sensitizer added, drying the photo emulsion, creating a film positive for the graphic, exposing the photo emulsion to a high intensity light source to cure the emulsion so it doesn't wash out. The present disclosure eliminates the entire process.

Secondly. The disclosed ink eliminates the need to take the print job offline for applying expensive laminate films or applying clear coats that protect the graphics. By applying the graphics and coating inline via the ink jet printing, the cost is reduced by approximately 50-75% in labor and materials.

The clear laminate ink disclosed herein reduces production time lost due to taking print jobs offline for processing and enables flexibility in printing of short runs or even one offs because of the automated nature of application. The clear laminate ink further eliminates use of harsh chemicals associated to screen printing. The laminate ink further enables instant on and Instant off print production to minimize pre-production set up time.

Radiation curable inks are generally composed of monomeric and oligomeric materials, pigments, initiators, and additives. Radiation curable inks are printed on numerous substrates, both rigid and flexible, e.g., polyvinyl chloride (PVC), polystyrene, polycarbonate, acrylonitrile-butadiene-styrene (ABS), polyester, polyolefins, and textile materials. The ink performance, e.g., adhesion, scratch and rub resistance, flexibility, hardness, etc. are highly dependent on the ink compositions, especially the properties of the monomeric and oligomeric materials used in the ink compositions. An ultraviolet (UV) lamp is generally used to cure radiation curable inks. The ink disclosed herein is focused on having a texture, appearance, and protective qualities consistent with existing laminate layers.

The clear laminate ink provides the ability to print a UV clear coat via UV inkjet that offers the same performance capabilities that of expensive laminate films such as abrasion resistance, chemical resistance, and longevity of the printed media. For purposes of this disclosure, a laminate or laminate layer is one that exhibits abrasion resistance, chemical resistance, and environmental resistance (e.g., solar, weather). The laminate ink enhances the chemical resistance of a given printed graphic. The laminate ink further exhibits a high elongation characteristic, so the laminate ink is capable of application over rough surfaces and rivets. The laminate ink seals the colored inks giving them resistance to gasoline, oil, Isopropyl Alcohol, denatured alcohol, and various cleaning solutions associated with the cleaning of fleet graphics.

The technology behind the laminate ink additionally offers the final printed graphics protection from fading of the pigments, gloss reduction and cracking when subjected to the suns UV rays and the harsh environment and offers extended life to the printed media.

The laminate ink has an even higher elongation characteristic, when printed on selected pressure sensitive vinyl films (achieves over 130% elongation). The increased elongation benefit is important due to the fact that in some work product contexts, the printed graphics must conform over rivets and around the edges of the fleet vehicles. When the elongation is too low, cracking of the media will be present.

The laminate ink is made possible by using a precise and complex combination of reactive diluents that include Aliphatic Urethane Acrylates that offer high elongation and non-yellowing properties and are low in viscosity to maintain the viscosity of the ink jet coating below which is no greater than 12 centipoises. The reactive monomer (s) of choice are important to this type of chemistry as the formulation contains 70% reactive monomers. The function of the reactive monomers, which are a building block to the formulation, are to help with adhesion characteristics, viscosity adjustment, cure response, and to a degree, flexibility to the system.

The monomers used are Difunctional and Monofunctional in nature. Embodiments of the laminate ink achieve the balance between the two functionalities in order to maintain a preferred cure for the chemical resistance and to maintain the flexibility or elongation to conform over rivets and to be creased around the edges of the fleet vehicles in relevant contexts. A coating utilizing a higher percentage of a Difunctional monomer results in great chemical resistance but will not have the flexibility to conform around rivets or other physical obstructions and/or be flexed. A coating that contains a higher percentage of the monofunctional monomer would be the opposite—poor chemical resistance but greater flexibility. A user would formulate the laminate ink and adjust the balance of Difunctional and Monofunctional reactive monomers based on the intended context.

The clear ink uses a specific blend of photoinitiators to achieve a preferred amount of surface cure, gloss, and scratch resistance. The peak absorbance range is between 250-400 nanometers of the photoinitiator. A combination of these photoinitiator properties replicates traditional lamination characteristics. In some embodiments, the combined levels are kept between 4-12% by weight in order to not under cure nor over cure the coating to the point where the laminate ink loses desired physical properties. In some contexts, the photoinitiators of choice are difunctional alpha-hydroxy ketone that operates in the 260-nanometer range and a 2,4,6, Trimethylbenzoyldiphenylphosphine oxide operating in the 350-400 nanometer range.

Another important part of the chemistry of the laminate ink is incorporation of UV absorbers and hindred amine light stabilizers (HALS). These additives protect the graphics layer from both UV-A and UV-B Light rays. More specifically, these additives protect against a variety of degrading influences such as light, weather, cracking of the media as well as other environmental hazards.

The above ink components each contribute toa desirable feature of the laminate ink that enables the ink to replicate the characteristics of laminated materials.

### Monomer Component

Examples of mono-functional monomers include, but are not limited to, tetrahydrofurfuryl acrylate, tetrahydrofurfuryl methacrylate, vinyl caprolatam, isobornyl acrylate, isobornyl methacrylate, 2-phenoxyethyl acrylate, 2-phenoxyethyl methacrylate, 2-(2-ethoxyethoxy) ethyl acrylate, isooctyl acrylate, isodecyl acrylate, isodecyl methacrylate, lauryl acrylate, lauryl methacrylate, stearyl acrylate, stearyl methacrylate, cyclic trimethylolpropane formal acrylate, 3,3,5-trimethylcyclohexane acrylate, and monofunctional methoxylated PEG (350) acrylate, etc.

Examples of difunctional monomers include, but not are limited to, diacrylates or dimethacrylates of diols and polyetherdiols, such as propoxylated neopentyl glycol diacrylate, 1, 6-hexanediol diacrylate, 1, 6-hexanediol dimethacrylate, 1,3-butylene glycol diacrylate, 1,3-butylene glycol dimethacrylate 1,4-butanediol diacrylate, 1,4-butanediol dimethacrylate, alkoxylated aliphatic diacrylate (e.g., SR9209A from Sartomer®), diethylene glycol diacrylate, diethylene glycol dimethacrylate, dipropylene glycol diacrylate, tripropylene glycol diacrylate, triethylene glycol dimethacrylate, and alkoxylated hexandiol diacrylates, e.g., SR562, SR563, SR564 from Sartomer®.

### Photoinitiator Component

The ink compositions comprise a photoinitiator component. In the radiation curing process, the photoinitiator component initiates the curing in response to incident radiation. The selection of the type of the photoinitiator component in the ink compositions is generally dependent on the wavelength of curing radiation and the colorant employed in the ink compositions. It is preferred that the peak absorption wavelengths of selected photoinitiator vary with the range of wavelength of curing radiation to effectively utilize radiation energy, especially using ultraviolet light as radiation.

Examples of photoinitiators include, but are not limited to, 1-hydroxycyclohexylphenyl ketone, 4-isopropylphenyl-2-hydroxy-2-methyl propan-1-one, 1-[4-(2-hydroxyethoxy)-phenyl]-2-hydroxy-2-methyl-1-propan-1-one, 2,2-dimethyl-2-hydroxy-acetophenone, 2,2-dimethoxy-2-phenylacetophenone, 2-hydroxy-2-methylpropionphenone, Diphenyl (2,4,6-trimethylbenzoyl) phosphine oxide, bis(2,6-dimethoxy-benzoyl)-2,4,6 trimethyl phenyl phosphine oxide, 2-methyl-1-1[4-(methylthio)phenyl]-2-morpholino-propan-1-one, 3,6-bis(2-methyl-2-morpholino-propionyl)-9-n-octylcarbazole, 2-benzyl-2-(dimethylamino)-1-(4-morpholinyl) phenyl)-1-butanone, benzophenone, 2,4,6-trimethylbenzophenone, isopropyl thioxanthone. Blends of photoinitiators commercially available include, but are not limited to, those under the designations of Darocur 4265, Irgacure 2022, Irgacure 2100 from Ciba® Specialty Chemicals; and Esacure KT37, Esacure KT55, Esacure KTO046 from Lam berti®.

In some embodiments, the photoinitiator component can further comprise a co-initiator. The co-initiator component is used to activate photoinitiators to initiate polymerization or is used to improve the surface curing of ink by mitigating oxygen inhibition to free radicals generated by photoinitiators. Examples of suitable co-initiators include, but are not limited to, those under the designations of CN386, CN384, and CN383 from Sartomer®.

### Additive Component

In some embodiment of the invention, the ink compositions further comprise an additive component. Various additives can be included in the ink compositions, including a surfactant, a leveling additive, a stabilizer, etc.

A surfactant is used to reduce the surface tension of the ink compositions to improve wetting property of the inks on substrates. It is preferred that the surfactant comprises at least one polysiloxane acrylate, also known as a silicone acrylate, which participates in the radiation curing process to be part of cured ink. Examples of surfactant include, but are not limited to, those under the designations of Tegorad 2200N, Tegorad 2100, and Tegorad 2300 from Goldschmidt® Chemical Corp., and BYK 377, BYK 3510, BYK 307, and BYK 330 from BYK Chemie®.

In some embodiments, a leveling additive is used to improve the flowing property of ink to produce a more uniform surface of ink film. Examples of leveling agents include, but are not limited to, those under the designation of BYK 361N, BYK 353, and BYK 354 etc. from BYK Chemie®.

In some embodiments, a stabilizer is used to improve shelf life and photolytic stability of ink compositions. Stabilizers in the ink compositions can include an ultraviolet light stabilizer, a free radical scavenger stabilizer, etc. Examples of ultraviolet light stabilizers include ultraviolet absorber stabilizer and hindered amine light stabilizer. These stabilizers are used to improve the outdoor durability and weatherability of cured ink. Commercially available ultraviolet light stabilizers include, but are not limited to, those under the designation of Tinuvin 460, Tinuvin 479, Tinuvin171, Tinuvin 928, Tinuvin123, and Tinuvin 292 from Ciba® Specialty Chemicals, etc.

In some embodiments, a free radical scavenger stabilizer is used to improve the stability of ink against heat. Examples of a free radical scavenger include, but are not limited to, hydroquinone, 4-methoxyphenol, hindered phenol, etc. A small amount is preferably used in the ink compositions to minimize their interference with the radiation curing process.

### Application

The ink compositions can be printed on an ink jet printer. Any conventional ink jet printer is acceptable. In some embodiments, the ink jet printed is a single pass, UV curing system. During the single pass of the print head, first the colored ink is laid down and then the clear, laminate ink is applied on top (e.g., on an external layer of the work piece). In various embodiments the colored ink is cured separately from the clear, laminate ink. A suitable inkjet would include each Roll to Roll printers using Super Range and Super Flex inks as produced by Electronics For Imaging, Inc.®.

In one embodiment, the ink jet printer includes a component for radiation curing of the ink. In another embodiment, the radiation curing component is a separate assembly. Non-limiting examples of suitable radiation sources for UV curing include high-pressure or low-pressure mercury vapor lamps, with or without doping, or electron beam sources. Their arrangement is known in principle and may be adapted to the circumstances of the substrate for printing and the process parameters. In some embodiments, the clear laminating ink replaces a white channel. In some inkjet printers a white channel goes unused, and thus inclusion in that channel causes minimal to no disruption of the inkjet's otherwise existing functions.

### EXAMPLE

The example depicts three clear ink compositions. The ink compositions are shown in table 1 and the ink properties are shown in table 2. Composition indicates percentage by weight for each component. The examples are provided as illustrative and are not intended as the only ink compositions that are capable of embodying the invention disclosed herein. Ink compositions A-C are comparable in function and characteristics and are substitutes. The ink composition that one would use is context dependent (e.g., the type of work product produced), and some ink characteristics would be modified to match the specific goals of a given context. A person of ordinary skill in the art will recognize, though, that the ink composition and properties can be tuned as desired.

TABLE 1
Ink Composition

| | | Com- | | | |
|---|---|---|---|---|---|
| | | posi- | | | |
| | | tion | Comp. | Comp. | |
| Component | Chemical Name | A | B | C | Ranges |
| SR339 | 2- | 23.65 | 23.65 | 23.65 | 15.00-25.00 |
| | PHENOXYETHYL | | | | |
| | ACRYLATE | | | | |
| V-PYROL | N- | 20.00 | 20.00 | 20.00 | 15.00-25.00 |
| | VINYL- | | | | |
| | PYRROLIDONE | | | | |
| SR506 A | ISOBORNYL | 15.00 | 15.00 | 15.00 | 12.00-17.00 |
| | ACRYLATE | | | | |
| SR238B | 1,6 HEXANEDIOL | 4.00 | 4.00 | 4.00 | 3.00-8.00 |
| | DIACRYLATE | | | | |
| SR335 | LAURYL | 7.00 | 7.00 | 7.00 | 4.00-9.00 |
| | ACRYLATE | | | | |
| CN991 | URETHANE | 12.50 | 0 | 0 | 10.00-15.00 |
| | ACRYLATE | | | | |
| BYK-361N | POLYACRYLATE | 0.50 | 0.50 | 0.50 | .40-.80 |
| BYK-377 | POLYETHER | 0.05 | 0.05 | 0.05 | 0.00-0.10 |
| | MODIFIED | | | | |
| | POLYDIMETHYL | | | | |
| | SILOXANE | | | | |
| GENOMER | AMINE | 4.00 | 4.00 | 4.00 | 2.00-5.00 |
| 5271 | ACRYLATE | | | | |
| GR-TPO | PHOTO- | 8.00 | 8.00 | 8.00 | 7.00-10.00 |
| | INITIATOR | | | | |
| TR-PPI- | PHOTO- | 2.00 | 2.00 | 2.00 | 1.50-3.00 |
| ONE | INITIATOR | | | | |
| GENORAD | STABILIZER | 0.50 | 0.50 | 0.50 | 0.40-0.60 |
| 20 | | | | | |
| TINUVIN | HYDROXPHENYL | 2.00 | 2.00 | 2.00 | 1.75-2.25 |
| 400 | TRIAZINE (HPT) | | | | |
| | UV ABSORBER | | | | |
| TINUVIN | HINDERED | 0.80 | 0.80 | 0.80 | 0.70-1.00 |
| 622 SF | AMINE | | | | |
| | LIGHT | | | | |
| | STABILIZER | | | | |
| | (HALS) | | | | |
| Miramer | URETHANE | 0 | 12.50 | 0 | 10.00-15.00 |
| PU2200LV | ACRYLATE | | | | |
| Miramer | URETHANE | 0 | 0 | 12.50 | 10.00-15.00 |
| PU2204 | ACRYLATE | | | | |

TABLE 2
Ink Property

| Testing | Ink |
|---|---|
| Viscosity at 45 C. (cP) | 11.40 Centipoise |
| Adhesion on PSA Vinyls | 3M controltac and Avery 2105 and |
| | 1105 100% |
| Curing Energy | 140 mj/cm2 |
| Elongation | 130% |
| Surface Tension | 24.20 Newons Per Meter |

### Method

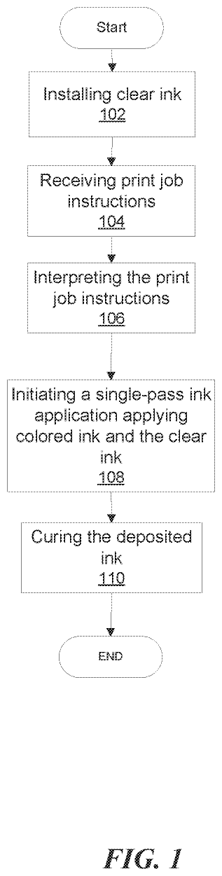

FIG. 1 is a flowchart illustrating a method of employing clear ink laminate. In step 102, an inkjet printer includes an installation of a clear ink that configured to substitute as a laminate layer. In some embodiments, the inkjet printer is a single-pass UV-curing printing apparatus. In some embodiments, the clear ink is installed in a white channel of the inkjet printer. The ink may be installed by a technician or user of the inkjet printer, or the printer is sold including the clear ink pre-installed.

In step 104, the inkjet printer receives print job instructions. The print job instructions include a run of work products that the inkjet printer is to generate. The instructions include both graphics and an instruction to laminate over the graphics. The graphics are typically generated using the colored inks that the inkjet printer is equipped with.

In step 106, the inkjet printer interprets the print job instructions to allocate use and placement of the clear ink during the single-pass ink application. In step 108, the inkjet printer initiates a single-pass ink application applying colored ink and the clear ink onto a workpiece, wherein the colored ink is implemented as a graphic layer and the clear ink is implemented as a laminate layer external to the graphic layer.

Notably, this is a single step in the process to both apply graphics and laminate those graphics. In prior art implementations, a technician had to remove a given work piece from the printing apparatus (inkjet or otherwise) and put the work piece into a second laminating machine. In addition to the labor costs, there are laminate screen costs that exceed the cost of inkjet ink. Thus, the present method reduces the cost of both materials and labor.

While both the clear laminate ink and the ink used to produce the graphics are applied simultaneously with respect to passes of the print head, the ink is applied sequentially with respect to the ink channels. The ink channels cause the ink for the graphics to be applied first on a lower layer, and the clear laminate ink to be applied second on an external layer.

In step 110, the inkjet printer cures the deposited ink such as with a UV curing lamp. The timing of the curing step varies based on implementation. In some embodiments, the colored ink is first cured and then the laminate ink is deposited and cured. In other embodiments, the colored ink is applied, then the laminate ink is applied, and then both are cured simultaneously.

Steps 108 and 110 are repeated for each item in the print run as indicated in the print job instructions and interpretation thereof (e.g., the printer settings indicate print job overruns).

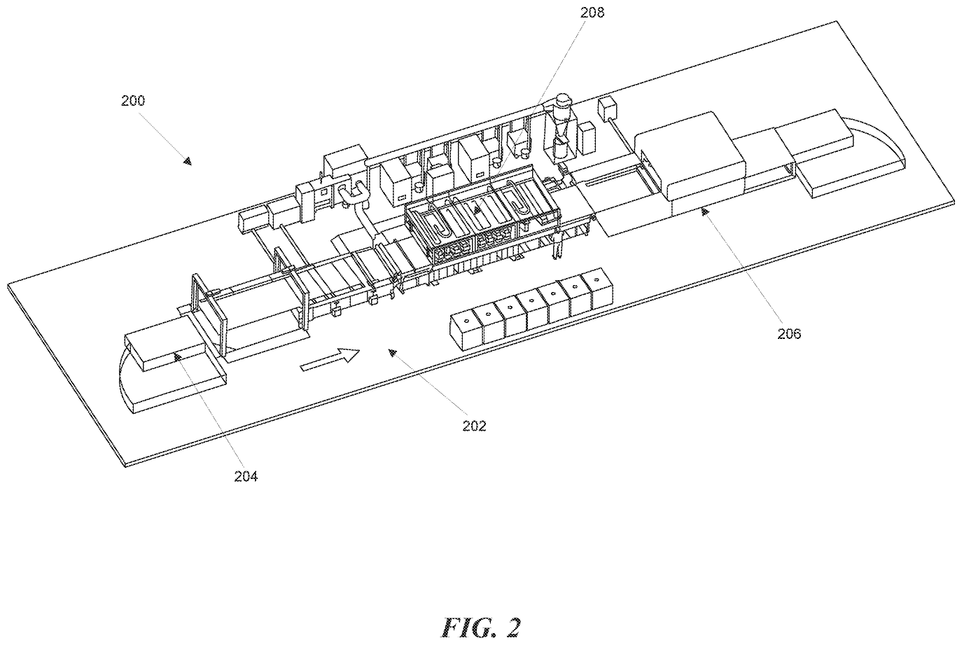

FIG. 2 is an illustration of a single-pass inkjet printer. The illustrated printer 200 is for industrial use. The printer 200 includes a production line 202 including a conveyor system (in this case, left to right) for propelling sheets along through the printer 200. On the left side of the production line 202 is the sheet bay 204 from which the production line 202 draws sheets. On the far right side of the production line 202 is a stacker 206. The stacker 206 directs printed sheets to reject or accept repositories.

In the center of the production line 202 is the single-pass inkjet 208. The inkjet depicted includes seven inks, though in various embodiments of a single-pass inkjet a number of ink colors may be selected. The particular inkjet 208 pictured includes a number of bays to insert various inks. As sheets pass below the inkjet 208 (a single time), the nozzles of the print head apply ink to the sheets. The laminate ink is installed into one of the ink bays.

### Computer System

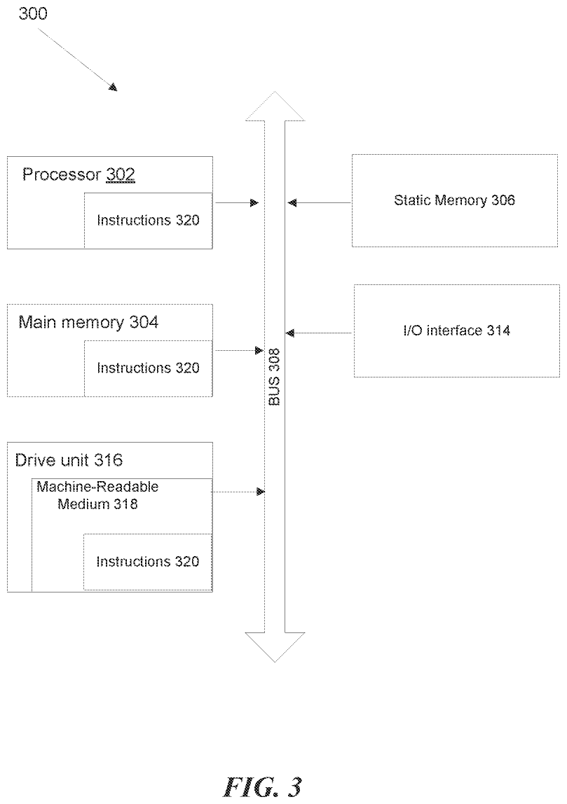

FIG. 3 shows a diagrammatic representation of a machine in the example form of a computer system 300 within which a set of instructions for causing the machine to perform one or more of the methodologies discussed herein may be executed.

The computer system 300 may act as a control device in this disclosed and includes a processor 302, a main memory 304, and a static memory 306, which communicate with each other via a bus 308. The computer system 300 also includes an output interface 314; for example, a USB interface, a network interface, or electrical signal connections and/or contacts;

The disk drive unit 316 includes a machine-readable medium 318 upon which is stored a set of executable instructions, i.e., software 320, embodying any one, or all, of the methodologies described herein. The software 320 is also shown to reside, completely or at least partially, within the main memory 304 and/or within the processor 302. The software 320 may further be transmitted or received over a network by means of a network interface device 316.

In contrast to the system 300 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g., a computer. For example, a machine-readable medium includes read-only memory (ROM); random access memory (RAM); magnetic disk storage media; optical storage media; flash memory devices; electrical, optical, acoustical or other form of propagated signals such as carrier waves, infrared signals, digital signals, etc.; or any other type of media suitable for storing or transmitting information.

Further, it is to be understood that embodiments may include performing operations and using storage with cloud computing. For the purposes of discussion herein, cloud computing may mean executing algorithms on any network that is accessible by internet-enabled or network-enabled devices, servers, or clients and that do not require complex hardware configurations (e.g., requiring cables and complex software configurations, or requiring a consultant to install). For example, embodiments may provide one or more cloud computing solutions that enable users, e.g., users on the go, to access real-time video delivery on such internet-enabled or other network-enabled devices, servers, or clients in accordance with embodiments herein. It further should be appreciated that one or more cloud computing embodiments include real-time video delivery using mobile devices, tablets, and the like, as such devices are becoming standard consumer devices.

As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Accordingly, the disclosure of the invention is intended to be illustrative, but not limiting, of the scope of the invention, which is set forth in the following Claims.

I/We claim:

1. A method comprising:
installing a clear ink that is inkjet compatible into a single-pass UV-curing printing apparatus; and
during a single-pass ink application, applying and curing colored ink and the clear ink onto a workpiece, wherein the colored ink is implemented as a graphic layer and the clear ink is implemented as a laminate layer external to the graphic layer.

2. The method of claim 1, wherein said installing positions the clear ink in a white channel.

3. The method of claim 1, further comprising:
receiving print job instructions; and
interpreting the print job instructions to allocate use and placement of the clear ink during the single-pass ink application.

4. The method of claim 1, wherein the clear ink includes Aliphatic Urethane Acrylates that are configured with high elongation and non-yellowing properties.

5. The method of claim 1, wherein the clear ink contains 70% reactive monomers.

6. The method of claim 1, wherein the clear ink has a peak absorbance range is between 250-400 nanometers of a photoinitiator.

7. The method of claim 1, wherein the clear ink includes combined levels of photoinitiator between 4-12% by weight.

8. The method of claim 1, wherein the clear ink has a plurality of photoinitiators including:
difunctional alpha-hydroxy ketone that operates in the 260-nanometer range; and
a 2,4,6, Trimethylbenzoyldiphenylphosphine oxide which operates in the 350-400 nanometer range.

9. The method of claim 1, wherein the clear ink incorporates UV absorbers and Hindred amine light stabilizers.

10. A system comprising:
a single-pass inkjet UV-curing printing apparatus; and
a clear ink installed in the single-pass inkjet UV-curing printing apparatus, wherein the printing apparatus is configured to apply and cure colored ink and the clear ink onto a workpiece, wherein the colored ink is implemented as a graphic layer and the clear ink is implemented as a laminate layer external to the graphic layer.

11. The system of claim 10, wherein the clear ink includes Aliphatic Urethane Acrylates that are configured with high elongation and non-yellowing properties.

12. The system of claim 10, wherein the clear ink contains 70% reactive monomers.

13. The system of claim 10, wherein the clear ink has a peak absorbance range is between 250-400 nanometers of a photoinitiator.

14. The system of claim 10, wherein the clear ink includes combined levels of photoinitiator between 4-12% by weight.

15. The system of claim 10, wherein the clear ink has a plurality of photoinitiators including:
difunctional alpha-hydroxy ketone that operates in the 260-nanometer range; and
a 2,4,6, Trimethylbenzoyldiphenylphosphine oxide which operates in the 350-400 nanometer range.

16. The system of claim 10, wherein the clear ink incorporates UV absorbers and (HALS)Hindred amine light stabilizers.

17. A clear ink composition comprising:
Aliphatic Urethane Acrylates that are configured with high elongation and non-yellowing properties;
70% reactive monomers;
UV absorbers;
Hindred amine light stabilizers; and
a plurality of photoinitiators, where combined levels of photoinitiator are between 4-12% by weight, with peak absorbance range is between 250-400 nanometers of the photoinitiators, the plurality of photoinitiators including:
difunctional alpha-hydroxy ketone that operates in the 260-nanometer range; and
a 2,4,6, Trimethylbenzoyldiphenylphosphine oxide which operates in the 350-400 nanometer range.

18. The clear ink composition of claim 17, wherein said clear ink is configured for installation in a white channel of a single-pass inkjet printing apparatus.

19. The clear ink composition of claim 17, wherein said clear ink is configured for application in a laminate layer external to a graphic layer including colored inks.

20. The clear ink composition of claim 17, wherein said clear ink is UV-cured.
